(19) United States
(12) Patent Application Publication
(10) Pub. No.: US 2022/0166702 A1
(43) Pub. Date: May 26, 2022

(54) FUZZING PREPROCESSING APPARATUS AND METHOD FOR AUTOMATING SMART NETWORK FUZZING

(71) Applicant: Electronics and Telecommunications Research Institute, Daejeon (KR)

(72) Inventors: Gae-Il AN, Daejeon (KR); Yang-Seo CHOI, Daejeon (KR)

(73) Assignee: Electronics and Telecommunications Research Institute, Daejeon (KR)

(21) Appl. No.: 17/135,505

(22) Filed: Dec. 28, 2020

(30) Foreign Application Priority Data
Nov. 24, 2020 (KR) 10-2020-0159321

(51) Int. Cl. H04L 12/26; H04L 29/06

(52) U.S. Cl. CPC H04L 43/18; H04L 69/18; H04L 63/123; H04L 63/1433

(57) ABSTRACT

Disclosed herein are a fuzzing preprocessing apparatus and method for automating smart network fuzzing. The fuzzing preprocessing method includes collecting communication message samples that are sent by a fuzzing target client to a fuzzing target system, comparing the communication message samples with each other, and then identifying sizes and types of fields of a fuzzing target protocol, determining a property of a protocol field value with reference to ASCII code, determining a coverage of a user field based on a response message to a test communication message that has been sent to the fuzzing target system, and storing a fuzzing protocol data model having a field number, a field type, a field size, a field value property, and a field value of the fuzzing target protocol, as elements.

### CROSS REFERENCE TO RELATED APPLICATION

This application claims the benefit of Korean Patent Application No. 10-2020-0159321, filed Nov. 24, 2020, which is hereby incorporated by reference in its entirety into this application.

### BACKGROUND OF THE INVENTION

### 1. Technical Field

Embodiments of the present disclosure relate to fuzzing technology for testing computer network software for security vulnerabilities, and more particularly to a fuzzing preprocessing method and apparatus which automatically generate a fuzzing target protocol data model so as to provide smart network fuzzing.

### 2. Description of the Related Art

Network Fuzzing is technology for finding errors or faults in network software while sending crafted communication messages to the corresponding network software.

Network fizzing technology is chiefly classified into dumb fuzzing and smart fuzzing depending on whether the network protocol used by fuzzing target software is known.

Dumb fuzzing is a method for first collecting normal protocol message samples from fuzzing target software and performing fuzzing while simply deforming the samples. This method is advantageous in that a network fuzzing function is easily implemented, but is disadvantageous in that code coverage for protocol messages is not large due to the lack of knowledge about the fuzzing target network protocol, and in that it takes a long time to perform the method because a test is performed using all possible input values.

Smart fuzzing is a method for generating a fuzzing target protocol data model by analyzing a communication message from fuzzing target software, and thereafter performing fuzzing while deforming a fuzzing message to be used for fuzzing based on the data model. This method is very efficient because fuzzing data is generated in conformity with the format of the fuzzing target protocol, but is problematic in that a lot of labor and time are consumed in analyzing a fuzzing target protocol.

As described above, the biggest issue in performing smart fuzzing is to automate the construction of a fuzzing protocol data model that is capable of generating fuzzing messages.

As conventional technology developed to generate a fuzzing protocol data model through the analysis of a fuzzing target communication message for a fuzzing target system that uses undocumented network protocols, there is Netzob described at https: //blog.amossys.fr/How_to_reverse_unknow_protocols_using_Netzob.html. Netzob helps a user generate a fuzzing protocol data model by providing a lexiconic inference function and a grammatical inference function for a network packet.

Netzob provides factor functions useful for analysis of a network protocol, but there is a limitation in that a user must perform programming while personally analyzing a fuzzing target network protocol so as to generate a fuzzing protocol data model. That is, which one of factor functions is to be selected and how the selected factor function is to be performed must be presented after the user individually analyzes the factor functions, thus making it impossible to currently automate the generation of a fuzzing protocol data model.

The conventional technology provides factor functions required in order to analyze the network protocol of a fuzzing target system, but does not provide a method that is capable of automatically generating a fuzzing protocol data model required in order to provide smart network fuzzing.

Therefore, there is required an efficient method that can automatically generate a fuzzing target protocol data model, which is required in order to automate smart network fuzzing.

### Prior Art Documents

### [Patent Documents]

(Patent Document 1) U.S. Pat. No. 9,654,490

### SUMMARY OF THE INVENTION

The following embodiment is intended to automatically generate a fuzzing protocol data model so that a smart network fuzzer can effectively generate a. required fuzzing communication message so as to find security vulnerabilities in computer network software.

In accordance with an aspect of the present invention to accomplish the above object, there is provided a fuzzing preprocessing method for automating smart network fuzzing, including collecting communication message samples that are sent by a fuzzing target client to a fuzzing target system, comparing the communication message samples with each other, and then identifying sizes and types of fields of a fuzzing target protocol, determining a property of a protocol field value with reference to American Standard Code for Information Interchange (ASCII) code, determining a coverage of a user field based on a response message to a test communication message that has been sent to the fuzzing target system, and storing a fuzzing protocol data model having a field number, a field type, a field size, a field value property, and a field value of the fuzzing target protocol, as elements.

Collecting the communication message samples may include requesting the fuzzing target client to send a communication message including specific user data to the fuzzing target system, and thereafter collecting a first sample message, requesting the fuzzing target client to send a communication message including user data identical to the specific user data to the fuzzing target system, and thereafter collecting a second sample message, and requesting the fuzzing target client to send a communication message including user data different from the specific user data to the fuzzing target system, and thereafter collecting a third sample message.

Identifying the sizes and the types of fields of the fuzzing target protocol is configured to, when lengths of the first sample message and the third sample message are different from each other, determine sizes of all fields of the fuzzing target protocol to be variable and thereafter measure the sizes of the fields, and when the lengths of the first sample message and the third sample message are identical to each other, measure the sizes of the fields of the fuzzing target protocol after the types of the fields have been determined.

The types of the fields of the fuzzing target protocol may include a constant field in which a fixed value is set, a user field in which a variable value is set, a sequence number field in which a sequence number of a corresponding message is set, a counter field in which lengths of fields are set, and a checksum field in which checksum data of the fields is set.

Identifying the sizes and the types of the fields of the fuzzing target protocol may be configured to determine a field in which contents of the first sample message and the third sample message are identical to each other to be a constant field, and determine a field in which contents of the first sample message and the third sample message are different from each other to be a control field, when a field value located in the control field is identical to lengths of fields, located subsequent to the control field, in each of request messages corresponding to the first sample message, the second sample message, and the third sample message, the control field is determined to be a counter field, and when the field value located in the control field is different from the lengths of fields, located subsequent to the control field, in a request message corresponding to each of the first sample message, the second sample message, and the third sample message, the control field is determined to be a checksum field.

Identifying the sizes and the types of the fields of the fuzzing target protocol may be configured to, when a field in which contents of the first sample message and the second sample message are different from each other is detected, determine the corresponding field to be a sequence number field, and when no field in which the contents of the first sample message and the second sample message are different from each other is detected, search the first sample message and the third sample message for a value input by a user, and determine a field including the value input by the user to be a user field when the field including the value input by the user is found.

The field value property of the fuzzing target protocol may be classified as one of a text property, a binary property, an integer (Int) property, and a floating-point number (Float) property.

Determining the coverage of the user field may include generating the test communication message while increasing a value of the user field, and then sending the test communication message to the fuzzing target system, determining a maximum value of the user field depending on whether an error is present in a response message to the test communication message that has been sent to the fuzzing target system, generating the test communication message while decreasing the value of the user field, and then sensing the test communication message to the fuzzing target system, and determining a minimum value of the user field depending on whether an error is present in a response message to the test communication message that has been sent to the fuzzing target system.

The fuzzing preprocessing method may further include generating a fuzzing communication message to be sent to the fuzzing target system based on the stored fuzzing protocol data model.

In accordance with another aspect of the present invention to accomplish the above object, there is provided a fuzzing preprocessing apparatus for automating smart network fuzzing, including a memory for storing at least one program, and a processor for executing the program, wherein the program performs collecting communication message samples that are sent by a fuzzing target client to a fuzzing target system, comparing the communication message samples with each other, and then identifying sizes and types of fields of a fuzzing target protocol, determining a property of a protocol field value with reference to ASCII code, determining a coverage of a user field based on a response message to a test communication message that has been sent to the fuzzing target system, and storing a fuzzing protocol data model having a field number, a field type, a field size, a field value property, and a field value of the fuzzing target protocol, as elements.

Collecting the communication message samples may include requesting the fuzzing target client to send a communication message including specific user data to the fuzzing target system, and thereafter collecting a first sample message, requesting the fuzzing target client to send a communication message including user data identical to the specific user data to the fuzzing target system, and thereafter collecting a second sample message, and requesting the fuzzing target client to send a communication message including user data different from the specific user data to the fuzzing target system, and thereafter collecting a third sample message.

Identifying the sizes and the types of fields of the fuzzing target protocol may be configured to, when lengths of the first sample message and the third sample message are different from each other, determine sizes of all fields of the fuzzing target protocol to be variable and thereafter measure the sizes of the fields, and when the lengths of the first sample message and the third sample message are identical to each other, measure the sizes of the fields of the fuzzing target protocol after the types of the fields have been determined.

The types of the fields of the fuzzing target protocol may include a constant field in which a fixed value is set, a user field in which a variable value is set, a sequence number field in which a sequence number of a corresponding message is set, a counter field in which lengths of fields are set, and a checksum field in which checksum to data of the fields is set.

Identifying the sizes and the types of the fields of the fuzzing target protocol may be configured to determine a field in which contents of the first sample message and the third sample message are identical to each other to be a constant field, and determine a field in which contents of the first sample message and the third sample message are different from each other to be a control field, when a field value located in the control field is identical to lengths of fields, located subsequent to the control field, in a request message corresponding to each of the first sample message, the second sample message, and the third sample message, the control field is determined to be a counter field, and when the field value located in the control field is different from the lengths of fields, located subsequent to the control field, in a request message corresponding to each of the first sample message, the second sample message, and the third sample message, the control field is determined to be a checksum field.

Identifying the sizes and the types of the fields of the fuzzing target protocol may be configured to, when a field in which contents of the first sample message and the second sample message are different from each other is detected, determine the corresponding field to be a sequence number field, and when no field in which the contents of the first sample message and the second sample message are different from each other is detected, search the first sample message and the third sample message for a value input by a user, and determine a field including the value input by the user to be a user field when the field including the value input by the user is found.

The field value property of the fuzzing target protocol may be classified as one of a text property, a binary property, an integer (Int) property, and a floating-point number (Float) property.

Determining the coverage of the user field may include generating the test communication message while increasing a value of the user field, and then sending the test communication message to the fuzzing target system, determining a maximum value of the user field depending on whether an error is present in a response message to the test communication message that has been sent to the fuzzing target system, generating the test communication message while decreasing the value of the user field, and then sensing the test communication message to the fuzzing target system, and determining a minimum value of the user field depending on whether an error is present in a response message to the test communication message that has been sent to the fuzzing target system.

The program may further perform generating a fuzzing communication message to be sent to the fuzzing target system based on the generated protocol data model.

In accordance with a further aspect of the present invention to accomplish the above object, there is provided a fuzzing preprocessing method for automating smart network fuzzing, including collecting communication message samples that are sent by a fuzzing target client to a fuzzing target system, comparing the collected communication message samples with each other, and then identifying sizes and types of fields of a fuzzing target protocol, determining a property of a protocol field value classified as one of a text property, a binary property, an integer (Int) property, and a floating-point number (Float) property with reference to ASCII code, sending a test communication message, generated while increasing or decreasing a value of a user field, to the fuzzing target system, and thereafter determining a coverage of the user field based on whether an error is present in a response message from the fuzzing target system, storing a fuzzing protocol data model having a field number, a field type, a field size, a field value property, and a field value of the fuzzing target protocol, as elements, and generating a fuzzing communication message to be sent to the fuzzing target system based on the stored puzzling protocol data model.

Collecting the communication message samples may include requesting the fuzzing target client to send a communication message including specific user data to the fuzzing target system, and thereafter collecting a first sample message, requesting the fuzzing target client to send a communication message including user data identical to the specific user data to the fuzzing target system, and thereafter collecting a second sample message, and requesting the fuzzing target client to send a communication message including user data different from the specific user data to the fuzzing target system, and thereafter collecting a third sample message, identifying the sizes and the types of the fields of the fuzzing target protocol may be configured to determine a time point at which the sizes of the fields are to be measured depending on whether lengths of the first sample message and the third sample message are different from each other, and each of the types of the fields of the fuzzing target protocol may be identified as a constant field in which a fixed value is set, a user field in which a variable value is set, a sequence number field in which a sequence number of a corresponding message is set, a counter field in which lengths of fields are set, or a checksum field in which checksum data of the fields is set, based on results of comparative analysis of the first to third sample messages.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram of typical network fuzzing;

FIG. 2 is a schematic block configuration diagram of a fuzzing preprocessing apparatus for automating smart network fuzzing according to an embodiment;

FIG. 3 is a flowchart of a fuzzing preprocessing method for automating smart network fuzzing according to an embodiment;

FIG. 4 is a flowchart for explaining the step of collecting communication message samples that are specific fuzzing targets according to an embodiment;

FIG. 5 illustrates an example of a fuzzing communication message generated using an example of a fuzzing protocol data model in Table 2;

FIGS. 6 to 8 are flowcharts for explaining the step of identifying the sizes and types of fields of a fuzzing target protocol according to an embodiment;

FIG. 9 is a flowchart for explaining the step of determining the coverage of a user field value through a test communication message according to an embodiment; and

FIG. 10 is a diagram illustrating the configuration of a computer system according to an embodiment.

### DESCRIPTION OF THE PREFERRED EMBODIMENTS

Advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not interpreted as having ideal or excessively formal meanings unless they are definitely defined in the present specification.

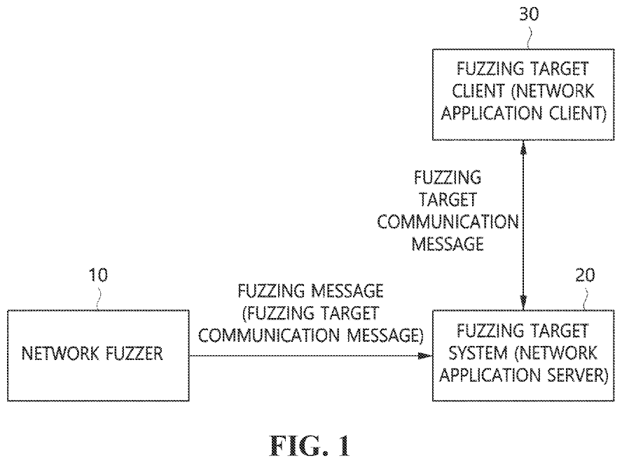

Hereinafter, a fuzzing preprocessing apparatus and method for automating smart network fuzzing according to embodiments will be described in detail with reference to FIGS. 1 to 10.

FIG. 1 is a conceptual diagram of typical network fuzzing.

Referring to FIG. 1, a network fuzzer 10 sends a crafted fuzzing message to a network application server 20, which is the fuzzing target system, and monitors whether a crash occurs in the fuzzing target system 20 haying received the fuzzing message due to errors or faults.

As described above, as conventional technology for generating a fuzzing protocol data model required in order to perform fuzzing by analyzing undocumented network protocols, there is Netzob. Netzob provides factor functions (e.g., a function of grouping and showing network messages having similar/identical field content, etc.) useful for analysis of the network protocol of a fuzzing target system, but which one of the factor functions is to be selected and how the selected factor function is to be performed must be personally analyzed and programmed by a user. Thereby, the fuzzing protocol data model is currently generated by the personal effort of experts rather than being automatically generated.

Therefore, the described embodiment proposes technology for automatically generating a fuzzing protocol data model so that fuzzing communication messages required by the smart network fuzzer can be effectively generated so as to find security vulnerabilities in computer network software.

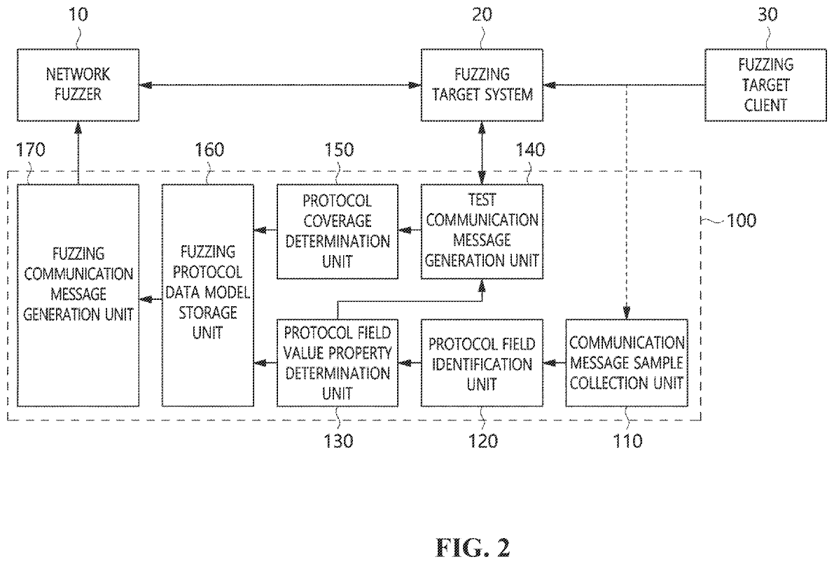

FIG. 2 is a block configuration diagram of a system including a fuzzing preprocessing apparatus for automating smart network fuzzing according to an embodiment.

Referring to FIG. 2, when a network fuzzer 10 sends a crafted fuzzing message to a fuzzing target system 20, a fuzzing communication message generated by a fuzzing preprocessing apparatus 100 for automating smart network fuzzing based on a fuzzing protocol data model is sent thereto.

For this, the fuzzing preprocessing apparatus 100 for automating smart network fuzzing according to an embodiment includes a communication message sample collection unit 110, a protocol field identification unit 120, a protocol field value property determination unit 130, a test communication message generation unit 140, a protocol coverage determination unit 150, a fuzzing protocol data model storage unit 160, and a fuzzing communication message generation unit 170.

The communication message sample collection unit 110 allows a fuzzing target client 30 to send a communication message composed of predefined specific values to the fuzzing target system 20, and thereafter collects a communication message sample corresponding to the communication message.

The protocol field identification unit 120 compares specific communication message samples collected by the communication message sample collection unit 110 with each other, and then identifies the sizes and types of fields of a fuzzing target protocol.

Here, the types of the fields of the fuzzing target protocol (i.e., protocol fields) may be classified into a constant field in which a fixed value is set, a user field in which a variable value is set, a sequence number field in which the sequence number of the corresponding message is set, a counter field in which the lengths of fields are set, a checksum field in which the checksum data of the fields is set, etc.

The protocol field value property determination unit 130 determines the properties of a protocol field value with reference to American Standard Code for Information Interchange (ASCII) code.

Here, the properties of the protocol field value may be classified into a text property (Text), a binary property (Binary), an integer property (Int), a floating-point number property (Float), etc.

The test communication message generation unit 140 generates a test communication message while increasing or decreasing the value of the user field, and sends the test communication message to the fuzzing target system 20.

The protocol coverage determination unit 150 determines the minimum value and the maximum value of the user field based on whether an error is present in a response message to the test communication message that has been sent to the fuzzing target system 20.

The fuzzing protocol data model storage unit 160 stores a fuzzing protocol data model composed of elements such as a field number (field ID), a field type, a field size, a field value property, and a field value.

Here, the field types may be classified into a constant field in which a fixed value is set, a user field in which a variable value is set, a sequence number field in which the sequence number of the corresponding message is set, a counter field in which the lengths of fields are set, a checksum field in which the checksum data of the fields is set, etc.

Here, the field value property is classified into a text property (Text), a binary property (Binary), an integer property (Int), a floating-point number property (Float), etc.

Here, the field value is configured such that a specific value, the range of the value (e.g., a minimum value and a maximum value), a field number, or the like is set depending on the field type.

The fuzzing communication message generation unit 170 generates an arbitrary fuzzing communication message using the fuzzing protocol data model.

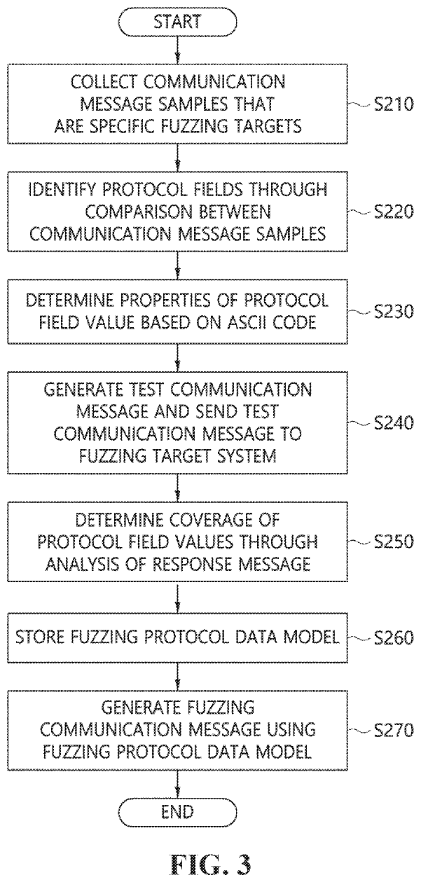

FIG. 3 is a flowchart illustrating a fuzzing preprocessing method for automating smart network fuzzing according to an embodiment.

Referring to FIG, 3, the fuzzing preprocessing method for automating smart network fuzzing according to the embodiment may include the step S210 of collecting communication message samples that are sent by a fuzzing target client to a fuzzing target system, the step S220 of comparing the collected communication message samples with each other and then identifying the sizes and types of fields of a fuzzing target protocol, the step S230 of determining the properties of a protocol field value with reference to ASCII code, the steps S240 and S250 of determining the coverage of a user field based on a response message to a test communication message that has been sent to the fuzzing target system, the step S260 of storing a fuzzing protocol data model having, as elements, the field number (ID), field type, field size, field value property, and field value of the fuzzing target protocol, and the step S270 of generating a fuzzing communication message to be sent to the fuzzing target system based on the stored fuzzing protocol data model. That is, the fuzzing communication message generated at step S270 is used as a message for allowing the network fuzzer 10 to monitor the fuzzing target system 20.

Here, the step S210 of collecting communication message samples that are specific fuzzing targets is configured to allow the fuzzing target client to sends communication messages, each composed of predefined specific values, to the fuzzing target system and collecting the communication message samples corresponding to the communication messages.

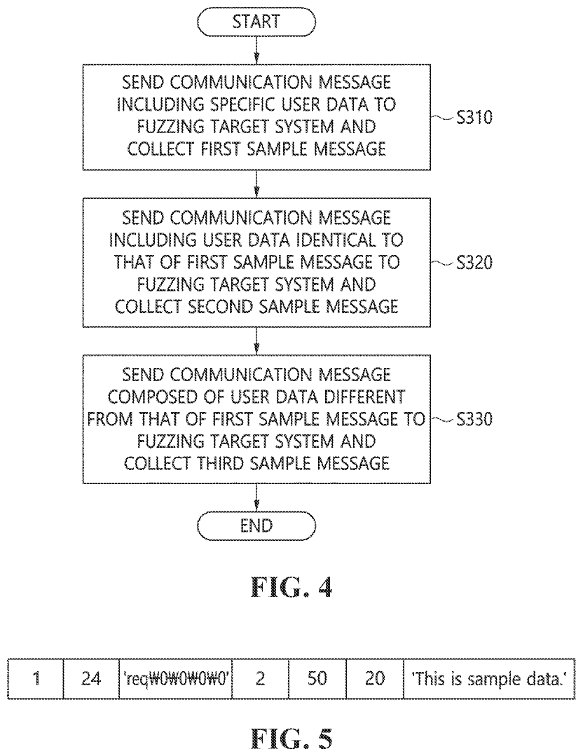

FIG. 4 is a flowchart for explaining the step of collecting communication message samples that are specific fuzzing targets according to an embodiment.

Referring to FIG. 4, in an embodiment, only three communication message samples are collected for respective fuzzing target protocol types.

In detail, the communication message sample collection unit 110 requests a fuzzing target client to send a communication message including specific user data to a fuzzing target system, and thereafter collects a first sample message at step S310.

Also, the communication message sample collection unit 110 requests the fuzzing target client to send a communication message including user data identical to the specific user data to the fuzzing target system, and thereafter collects a second sample message at step S320.

Finally, the communication message sample collection unit 110 requests the fuzzing target client to send a communication message including user data different from the specific user data to the fuzzing target system, and thereafter collects a third sample message at step S330.

Referring back to FIG. 3, the step S220 of identifying the sizes and types of the protocol fields through the comparison between specific message samples is configured to identify the sizes and types of the fields of the fuzzing target protocol by comparing the collected specific message samples with each other. Here, the types of the protocol fields may he classified into a constant field in which a fixed value is set, a user field in which a variable value is set, a sequence number field in which the sequence number of the corresponding message is set, a counter field in which the lengths of fields are set, a checksum field in which the checksum data of the fields is set, etc.

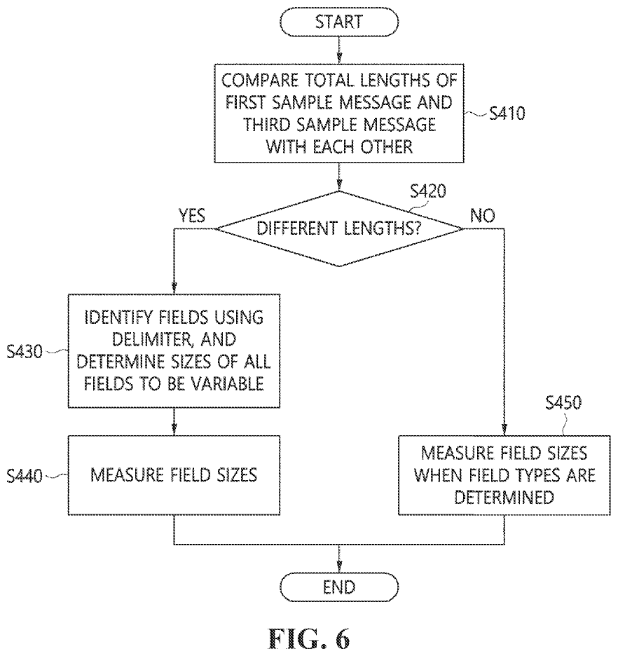

Here, as described above, the sizes and types of the fields of the fuzzing target protocol are identified by comparatively analyzing the first to third sample messages. A detailed description thereof will be made later with reference to FIGS. 6 to 8.

The properties of the protocol field value determined at the step S230 of determining the properties of the protocol field value with reference to ASCII code may be classified into text, binary, integer (Int), and floating-point number (Float) properties.

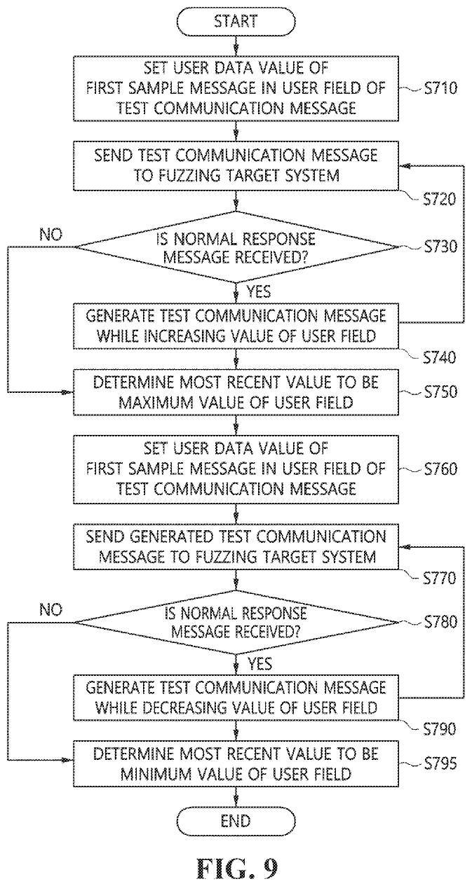

The steps S240 and S250 of determining the coverage of the user field based on the response message to the test communication message that has been sent to the fuzzing target system may include the step S240 of generating the test communication message while increasing or decreasing the value of the user field, and of sending the test communication message to the fuzzing target system, and the step S250 of determining the maximum value and the minimum value of the user field to be the coverage of the user field depending on whether an error is present in the response message to the test communication message that has been sent to the fuzzing target system. A detailed description thereof will be made later with reference to FIG. 9.

The step S260 of storing the fuzzing protocol data model is the step of storing, the fuzzing protocol data model composed of elements such as a field number (ID), a field type, a field size, a field value property, and a field value.

Table 1 shows the configuration of a fuzzing protocol data model according to an embodiment.

TABLE 1

| Element name | Element type | Valid value of element |
|---|---|---|
| Field number | Integer Type (Int) | 1~ |
| (Field ID) | | |
| Field Type | Enumeration type | Constant (constant field), User (user |
| | (Enum) | field) Counter (counter field), |
| | | SequenceNumber (sequence number |
| | | field) CheckSum (checksum field) |
| Field size | Integer type (Int) | 1~ |
| Field value | Enumeration type | Text, Binary, Int, or Float |
| property | (Enum) | |
| (Value | | |
| Property) | | |
| Field value | List type (list) | A field value, a field value range, and |
| | | a field number are stored depending |
| | | on the field type |

In Table 1, the field type element is classified into a constant field in which a fixed value is set, a user field in which a variable value is set, a sequence number field in which the sequence number of the corresponding message is set, a counter field in which the lengths of fields are set, a checksum field in which the checksum data of the fields is set, etc.

The field value property element is classified into text, binary, integer (Int), and floating-point number (Float) properties.

The field value element is configured such that a specific value, the range of the value (e.g., the minimum value and the maximum value), a field number, or the like is set depending on the field type.

Table 2 shows an example of the fuzzing protocol data model.

TABLE 2

| Field ID | Field Type | Field Size | Value Type | Field Value |
|---|---|---|---|---|
| 1 | Constant | 4 | — | [1] |
| 2 | SeqNo | 4 | Int | [24, 100000, 1] |
| 3 | Constant | 8 | — | [‘req\0\0\0\0’] |
| 4 | Coustant | 4 | Int | [0, 1, 2, 3] |
| 5 | User | 4 | Int | [0, 100] |
| 6 | Counter | 4 | Int | [7, 7] |
| 7 | User | 0 | Text | [1, 10240] |

In Table 2, the field value of field ID #2 indicating a sequence number field means that a start value thereof is 24, a last value thereof is 100000, and the field value is set by being increased by 1. The field value of field ID #4 indicating a constant field means that a settable value is one of 0, 1, 2, and 3. The field value of field ID #5 indicating a user field means that the value must be set to a value ranging from 0 to 100. The field value of field ID #6 indicating a counter field means that a field length of 7 ranging from #7 must be set.

FIG. 5 illustrates an example of a fuzzing communication message generated using the example of the fuzzing protocol data model of Table 2.

That is, referring to FIG. 5, based on the fuzzing protocol data model of Table 2, a first field is a constant field, the value of which is ‘1’, a second field is a sequence number field (SeqNo), the value of which is ‘24’, a third field is a constant field, the value of which is ‘req\0\0\0\0’, a fourth field is a constant field, the value of which is ‘2’, a fifth field is a user field, the value of which is ‘50’, a sixth field is a counter field, the value of which is ‘20’ indicating the length of text to be recorded in a seventh field, and the seventh field is a user field, the value of which is ‘This is sample data’ indicating text.

FIGS. 6 to 8 are flowcharts for explaining the step of identifying the sizes and types of fields of a fuzzing target protocol according to an embodiment.

FIG. 6 is a flowchart for explaining the step of identifying the length characteristics of a protocol message according to an embodiment.

Referring to FIG. 6, the protocol field identification unit 120 compares the total length of a first sample message with the total length of a third sample message at step S410.

This is performed based on the assumption that, when user data included in a request message corresponding to the first sample message is different from user data included in a request message corresponding to the third sample message, the sizes of the pieces of user data are also different from each other.

That is, if it is determined at step S420 that the total lengths of the first sample message and the third sample message are different from each other, the protocol field identification unit 120 identifies fields using a delimiter, determines the sizes of all protocol fields to be variable at step S430, and measures the sizes of the fields at step S440.

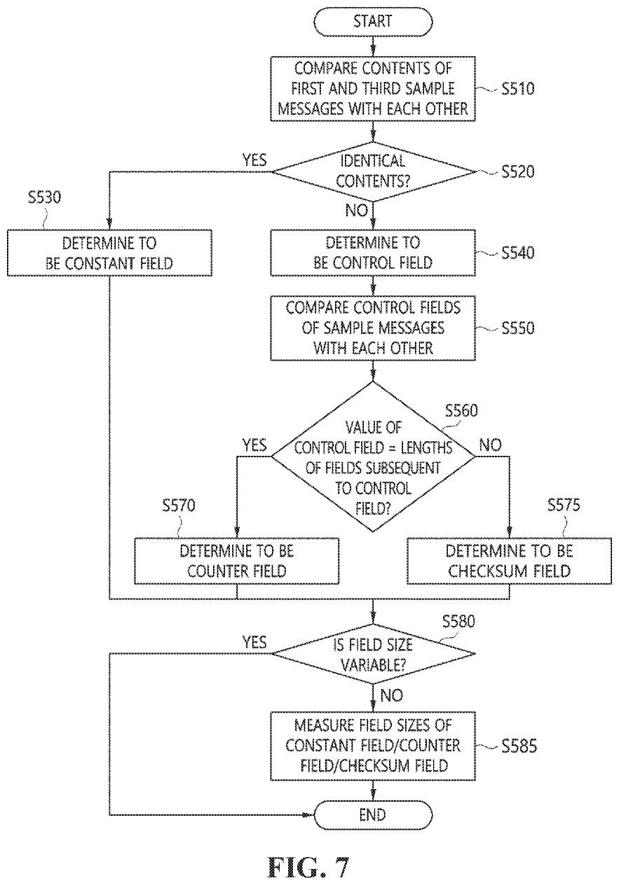

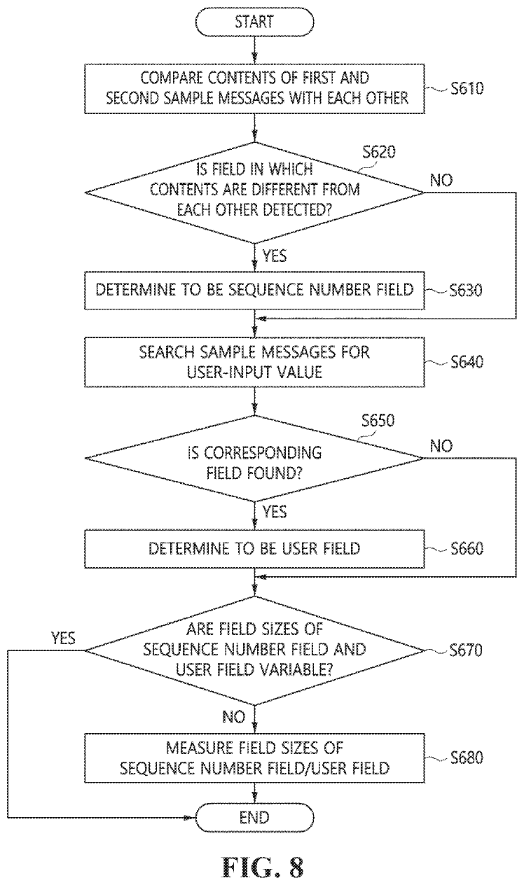

In contrast, if it is determined at step S420 that the total lengths of the first sample message and the third sample message are identical to each other, the protocol field identification unit 120 measures the sizes of fields at the time point at which the field types are determined at step S450. That is, as will be described below with reference to FIGS. 7 and 8, the field sizes are determined after the field types have been determined.

FIG. 7 is a flowchart for explaining the step of identifying a constant field, a counter field, and a checksum field according to an embodiment.

Referring to FIG. 7, the protocol field identification unit 120 may compare the contents of a first sample message and a third sample message with each other at step S510, and may then determine whether the contents of the first sample message and the third sample message are identical to each other at step S520. This is performed based on the assumption that the contents of the user data included in the first sample message and the third sample message are different from each other.

The protocol field identification unit 120 determines the field of the first sample message and the third sample message, in which the contents are determined to be identical to each other at step S520, to be a constant field at step S530.

In contrast, the protocol field identification unit 120 determines the field of the first sample message and the third sample message, in which the contents are determined to be different from each other at step S520, to be a control field at step S540.

The protocol field identification unit 120 determines whether a field value to located in the control field is identical to the lengths of fields located subsequent to the control field in each of response messages corresponding to the first sample message, the second sample message, and the third sample message at steps S550 and S560.

If it is determined at step S560 that the field value located in the control field is identical to the lengths of the corresponding fields, the protocol field identification unit 120 determines the control field to be a counter field at step S570. in contrast, if it is determined at step S560 that the field value located in the control field is not identical to the lengths of the corresponding fields, the protocol field identification unit 120 determines the control field to be a checksum field at step S575.

Thereafter, as described above, when the field size is not variable, the protocol field identification unit 120 measures the sizes of the constant field, the counter field, and the checksum field at steps S580 and S585.

FIG. 8 is a flowchart for explaining the step of identifying a sequence number field and a user field according to an embodiment.

Referring to FIG. 8, the protocol field identification unit 120 compares the contents of a first sample message and a second sample message with each other at step S610, and then checks whether a field in which the contents are different from each other is detected at step S620. This is performed based on the assumption that the contents of the user data included in the first sample message and the second sample message are identical to each other.

If it is determined at step S620 that a field in which the contents are different from each other is detected, the protocol field identification unit 120 determines the corresponding field to be a sequence number field at step S630.

On the other hand, if it is determined at step S620 that no field in which the contents are different from each other is detected, the protocol field identification unit 120 searches the sample messages for a value input by the user at step S640 and checks whether a field including the user-input value is found at step S650. That is, a field that is found as a result of searching the first sample message and the second sample message for the user that is data input when the first sample message and the second sample message are collected is determined to be a user field.

If it is determined at step S650 that a field including the user-input value has been found, the protocol field identification unit 120 determines the corresponding field to be a user field at step S660.

Thereafter, as described above, when the field size is not variable, the protocol field identification unit 120 measures the field sizes of the sequence number field and the user field at steps S670 and S680.

FIG. 9 is a flowchart for explaining the step of determining the coverage of a user field value through a test communication message according to an embodiment.

In FIG. 9, the steps S710 to S750 of determining the maximum value of a user field value through the test communication message and the steps S760 to S795 of determining the minimum value of the user field value through the test communication message are chiefly illustrated.

First, the test communication message generation unit 140 sets a user data value of the first sample message as an initial value of the user field of the test communication message at step S710. This is performed based on the assumption that the user data included in the first sample message is a normal value.

The test communication message generation unit 140 sends the generated test communication message to the fuzzing target system at step S720, and thereafter monitors whether a normal response message is received from the fuzzing target system at step S730.

As a result of the monitoring at step S730, when a normal response message is received, the test communication message generation unit 140 generates a test communication message in which an increased user field value is set at step S740. Thereafter, steps S720 to S740 are repeatedly performed.

On the other hand, as a result of the monitoring at step S730, when an error message is received, the test communication message generation unit 140 stops the repetition of steps S720 to S740, and the protocol coverage determination unit 150 determines the user field value of the test communication message that was most recently sent by the test communication message generation unit 140, to be the maximum value of the user field at step S750.

Again, the test communication message generation unit 140 sets the user data value of the first sample message as the initial value of the user field of the test communication message at step S760.

The test communication message generation unit 140 sends the generated test communication message to the fuzzing target system at step S770, and thereafter monitors whether a normal response message is received from the fuzzing target system at step S780.

As a result of the monitoring at step S780, when a normal response message is received, the test communication message generation unit 140 generates a test communication message in which a decreased user field value is set at step S790. Thereafter, steps S770 to S790 are repeatedly performed.

On the other hand, as a result of the monitoring at step S780, when an error message is received, the test communication message generation unit 140 stops the repetition of steps S770 to S790, and the protocol coverage determination unit 150 determines the user field value of a test communication message, which was most recently sent by the test communication message generation unit 140, to be the minimum value of the user field at step at step S795.

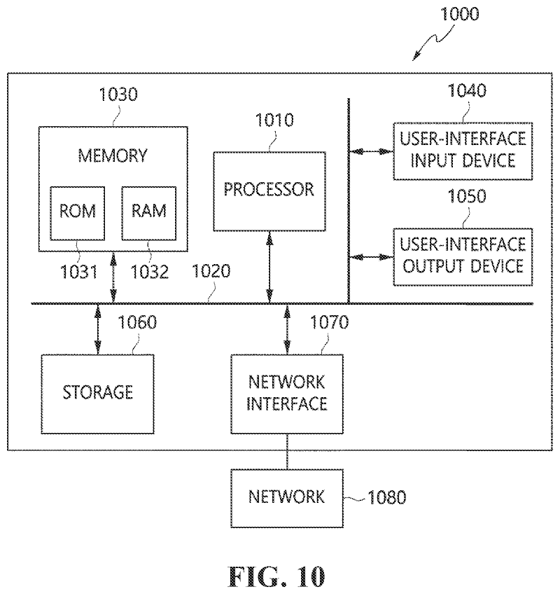

FIG. 10 is a diagram illustrating the configuration of a computer system according to an embodiment.

The fuzzing preprocessing apparatus 100 for automating smart network fuzzing according to an embodiment may he implemented in a computer system 1000, such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, or an information delivery medium. For example, the memory 1030 may include Read-Only Memory (ROM) 1031 or Random Access Memory (RAM) 1032.

In accordance with embodiments, since a fuzzing protocol data model may be automatically generated, smart network fuzzing having large code coverage and a high execution speed may be automatically provided, thereby avoiding the trouble of manually analyzing a fuzzing target network protocol.

Although the embodiments of the present invention have been disclosed with reference to the attached drawing, those skilled in the art will appreciate that the present invention can be implemented in other concrete forms, without changing the technical spirit or essential features of the invention. Therefore, it should be understood that the foregoing embodiments are merely exemplary, rather than restrictive in all aspects.

What is claimed is:

1. A fuzzing preprocessing method for automating smart network fuzzing, comprising:
collecting communication message samples that are sent by a fuzzing target client to a fuzzing target system;
comparing the communication message samples with each other, and then identifying sizes and types of fields of a fuzzing target protocol;
determining a property of a protocol field value with reference to American Standard Code for Information Interchange (ASCII) code;
determining a coverage of a user field based on a response message to a test communication message that has been sent to the fuzzing target system; and
storing a fuzzing protocol data model having a field number, a field type, a field size, a field value property, and a field value of the fuzzing target protocol, as elements.

2. The fuzzing preprocessing method of claim I, wherein collecting the communication message samples comprises:
requesting the fuzzing target client to send a communication message including specific user data to the fuzzing target system, and thereafter collecting a first sample message;
requesting the fuzzing target client to send a communication message including user data identical to the specific user data to the fuzzing target system, and thereafter collecting a second sample message; and
requesting the fuzzing target client to send a communication message including user data different from the specific user data to the fuzzing target system, and thereafter collecting a third sample message.

3. The fuzzing preprocessing method of claim 2, wherein identifying the sizes and the types of fields of the fuzzing target protocol is configured to:
when lengths of the first sample message and the third sample message are different from each other, determine sizes of all fields of the fuzzing target protocol to be variable and thereafter measure the sizes of the fields, and
when the lengths of the first sample message and the third sample message are identical to each other, measure the sizes of the fields of the fuzzing target protocol after the types of the fields have been determined.

4. The fuzzing preprocessing method of claim 2, wherein the types of the fields of the fuzzing target protocol include a constant field in which a fixed value is set, a user field in which a variable value is set, a sequence number field in which a sequence number of a corresponding message is set, a counter field in Which lengths of fields are set, and a checksum field in which checksum data of the fields is set.

5. The fuzzing preprocessing method of claim 4, wherein:
identifying the sizes and the types of the fields of the fuzzing target protocol is configured to:
determine a field in which contents of the first sample message and the third sample message are identical to each other to be a constant field, and
determine a field in which contents of the first sample message and the third sample message are different from each other to be a control field,
when a field value located in the control field is identical to lengths of fields, located subsequent to the control field, in each of request messages corresponding to the first sample message, the second sample message, and the third sample message, the control field is determined to be a counter field, and
when the field value located in the control field is different from the lengths of fields, located subsequent to the control field, in a request message corresponding to each of the first sample message, the second sample message, and the third sample message, the control field is determined to be a checksum field.

6. The fuzzing preprocessing method of claim 4, wherein identifying the sizes and the types of the fields of the fuzzing target protocol is configured to:
when a field in which contents of the first sample message and the second sample message are different from each other is detected, determine the corresponding field to be a sequence number field, and
when no field in which the contents of the first sample message and the second sample message are different from each other is detected, search the first sample message and the third sample message for a value input by a user, and determine a field including the value input by the user to be a user field when the field including the value input by the user is found.

7. The fuzzing preprocessing method of claim 1, wherein the field value property of the fuzzing target protocol is classified as one of a text property, a binary property, an integer (Int) property, and a floating-point number (Float) property.

8. The fuzzing preprocessing method of claim 4, wherein determining the coverage of the user field comprises:
generating the test communication message while increasing a value of the user field, and then sending the test communication message to the fuzzing target system;
determining a maximum value of the user field depending on whether an error is present in a response message to the test communication message that has been sent to the fuzzing target system;
generating the test communication message while decreasing the value of the user field, and then sensing the test communication message to the fuzzing target system; and
determining a minimum value of the user field depending on whether an error is present in a response message to the test communication message that has been sent to the fuzzing target system.

9. The fuzzing preprocessing method of claim 4, further comprising generating a fuzzing communication message to be sent to the fuzzing target system based on the stored fuzzing protocol data model.

10. A fuzzing preprocessing apparatus for automating smart network fuzzing, comprising:
a memory for storing at least one program; and
a processor for executing the program,
wherein the program performs:
collecting communication message samples that are sent by a fuzzing target client to a fuzzing target system;
comparing the communication message samples with each other, and then identifying sizes and types of fields of a fuzzing target protocol:
determining a property of a protocol field value with reference to ASCII code;
determining a coverage of a user field based on a response message to a test communication message that has been sent to the fuzzing target system; and
storing a fuzzing protocol data model having a field number, a field type, a field size, a field value property, and a field value of the fuzzing target protocol, as elements.

11. The fuzzing preprocessing apparatus of claim 10, wherein collecting the communication message samples comprises:
requesting the frizzing target client to send a communication message including specific user data to the fuzzing target system, and thereafter collecting a first sample message;
requesting the fuzzing target client to send a communication message including user data identical to the specific user data to the fuzzing target system, and thereafter collecting a second sample message; and
requesting the fuzzing target client to send a communication message including user data different from the specific user data to the fuzzing target system, and thereafter collecting a third sample message.

12. The fuzzing preprocessing apparatus of claim 11, wherein identifying the sizes and the types of fields of the fuzzing target protocol is configured to:
when lengths of the first sample message and the third sample message are different from each other, determine sizes of all fields of the fuzzing target protocol to be variable and thereafter measure the sizes of the fields, and
when the lengths of the first sample message and the third sample message are identical to each other, measure the sizes of the fields of the fuzzing target protocol after the types of the fields have been determined.

13. The fuzzing preprocessing apparatus of claim 11, wherein the types of the fields of the fuzzing target protocol include a constant field in Which a fixed value is set, a user field in which a variable value is set, a sequence number field in which a sequence number of a corresponding message is set, a counter field in which lengths of fields are set, and a checksum field in which checksum data of the fields is set.

14. The fuzzing preprocessing apparatus of claim 13, wherein:
identifying, the sizes and the types of the fields of the fuzzing target protocol is configured to:
determine a field in which contents of the first sample message and the third sample message are identical to each other to be a constant field, and
determine a field in which contents of the first sample message and the third sample message are different from each other to be a control field.
when a field value located in the control field is identical to lengths of fields, located subsequent to the control field, in a request message corresponding to each of the first sample message, the second sample message, and the third sample message, the control field is determined to be a counter field, and
when the field value located in the control field is different from the lengths of fields, located subsequent to the control field, in a request message corresponding to each of the first sample message, the second sample message, and the third sample message, the control field is determined to be a checksum field.

15. The fuzzing preprocessing apparatus of claim 13, wherein identifying the sizes and the types of the fields of the fuzzing target protocol is configured to:
when a field in which contents of the first sample message and the second sample message are different from each other is detected, determine the corresponding field to be a sequence number field, and
when no field in which the contents of the first sample message and the second sample message are different from each other is detected, search the first sample message and the third sample message for a value input by a user, and determine a field including the value input by the user to be a user field when the field including the value input by the user is found.

16. The fuzzing preprocessing apparatus of claim 10, wherein the field value property of the fuzzing target protocol is classified as one of a text property, a binary property, an integer (Int) property, and a floating-point number (Float) property,

17. The fuzzing preprocessing apparatus of claim 13, wherein determining the coverage of the user field comprises:
generating the test communication message while increasing a value of the user field, and then sending the test communication message to the fuzzing target system;
determining a maximum value of the user field depending on whether an error is present in a response message to the test communication message that has been sent to the fuzzing target system;
generating the test communication message while decreasing the value of the user field, and then sensing the test communication message to the fuzzing target system; and
determining a minimum value of the user field depending on whether an error is present in a response message to the test communication message that has been sent to the fuzzing target system.

18. The fuzzing preprocessing apparatus according to claim 13, wherein the program further performs generating a fuzzing communication message to be sent to the fuzzing target system based on the generated protocol data model.

19. A fuzzing preprocessing method for automating smart network fuzzing, comprising:
collecting communication message samples that are sent by a fuzzing target client to a fuzzing target system;
comparing the collected communication message samples with each other, and then identifying sizes and types of fields of a fuzzing target protocol;
determining a property of a protocol field value classified as one of a text property, a binary property, an integer (Int) property, and a floating-point number (Float) property with reference to ASCII code;
sending a test communication message, generated while increasing or decreasing a value of a user field, to the fuzzing target system, and thereafter determining a coverage of the user field based on whether an error is present in a response message from the fuzzing target system,
storing a fuzzing protocol data model having a field number, a field type, a field size, a field value property, and a field value of the fuzzing target protocol, as elements; and
generating a fuzzing communication message to be sent to the fuzzing target system based on the stored puzzling protocol data model.

20. The fuzzing preprocessing method of claim 19, wherein:
collecting the communication message samples comprises:
requesting the fuzzing target client to send a communication message including specific user data to the fuzzing target system, and thereafter collecting a first sample message;
requesting the fuzzing target client to send a communication message including user data identical to the specific user data to the fuzzing target system, and thereafter collecting a second sample message; and
requesting the fuzzing target client to send a communication message including user data different from the specific user data to the fuzzing target system, and thereafter collecting a third sample message,
identifying the sizes and the types of the fields of the fuzzing target protocol is configured to determine a time point at which the sizes of the fields are to be measured depending on whether lengths of the first sample message and the third sample message are different from each other, and
each of the types of the fields of the fuzzing target protocol is identified as a constant field in which a fixed value is set, a user field in which a variable value is set, a sequence number field in which a sequence number of a corresponding message is set, a counter field in which lengths of fields are set, or a checksum field in which checksum data of the fields is set, based on results of comparative analysis of the first to third sample messages.
